(19) United States
(12) Patent Application Publication
(10) Pub. No.: US 2007/0286978 A1
(43) Pub. Date: Dec. 13, 2007

(54) LINER MATERIAL

(76) Inventor: Stephen R. Dennis, Danville, CA (US)

Correspondence Address: THE CLOROX COMPANY, P.O. BOX 24305, OAKLAND, CA, 94623-1305, US

(21) Appl. No.: 11/423,504

(22) Filed: Jun. 12, 2006

(51) Int. Cl. B32B 3/02

(52) U.S. Cl. 428/64.1

(57) ABSTRACT

Provided is a liner material that includes a substrate layer, an active material absorbed into or overlying the substrate layer, and a first protective layer overlying the active material on the top surface of said substrate layer. Optionally, a second protective layer underlies the bottom surface of the substrate layer. The protective layers are impermeable to the active material and are water-soluble. The protective layer precludes release of the active material from the substrate layer so long as the protective layers are intact and undissolved.

### BACKGROUND OF THE INVENTION

1. Field of the Invention

This invention relates to liner materials, and more specifically to fragranced liner materials used for container closure seals.

2. Description of the Related Art

Liner materials have had many applications in use with consumer products. In one example, liner material was used to produce container closure liquid seals well known to those or ordinary skill in the art. Typically in the prior art, liner materials were supplied in flat sheets and container closure seals, sized to fit inside a cylindrically shaped container closure, sometimes referred to as a bottle cap, were die-cut from the liner material sheet to form a thin disk. This closure seal was inserted into the plastic or metal container closure adjacent the inside surface of the top of the container closure before the container closure was secured on the container neck, sometimes referred to as a container spout. Typically, the container closure was secured to the container neck by means of a threaded connection or a snap-fit interference connection. The closure seal operated as a gasket to form a liquid tight seal between the container neck lip and the inside surface of the top of the container closure thus containing any liquid material inside the container whenever the container closure was firmly secured to the container neck. As the container closure was secured to the container neck, by, for example twisting of a threaded container closure about a threaded container neck, the inside surface of the top of the container closure and the upper lip of the container neck compressed the closure seal therebetween. As the closure seated to the neck lip, a liquid tight seal was formed and liquid leakage around the connection of the container closure and the container neck was precluded.

Another means to form a liquid tight seal at a container neck included so-called induction seals. Induction seals are also thin disks sized, however, somewhat larger than the lip of the container neck. In one prior art example, an induction seal was formed of electrically conductive seal material such as aluminum foil. The conductive seal material was secured to the container neck lip by means of a thermoset adhesive. The thermoset adhesive securing the inductive seal to the container neck lip was activated by heat generated in the seal by an alternating electrical inductive field. The closure seal and the thermoset adhesive formed a liquid tight seal about the container neck lip to contain liquid within the container. Induction seals were typically intended as an additional temporary seal for use in container transit and storage. A consumer typically punctured or removed the inductive seal before the first use of the liquid product contained in the container.

It was often desirable to include a fragrance material absorbed within or sprayed on the closure seal surface. Fragranced liner material was supplied to closure seal converters to form fragranced closure seals. Closure seals containing a fragrance component would exude the fragrance material into the headspace of the container between the liquid level surface and the top of the container. Fragranced closure seals were marketed to provide scents in products so that when a consumer opened the container, a “whiff” of fragrance was noticed.

Fragranced closure seals were particularly advantageous when the liquid product contained in the container was incompatible with or destructive of the desired fragrance material. For example, sodium hypochlorite solutions, such as common household laundry bleach, are particularly destructive of most fragrance materials by oxidation of the fragrance. Most consumer pleasing fragrances are not amenable to direct mixing with these hypochlorite solutions.

However, historically there were problems in converting fragrance liner material. One particular disadvantage of using fragranced liner material to form closure seals was the emanation of the fragrance material from the liner stock to the manufacturing floor during conversion of the liner stock to closure seals. High concentration of the fragrance built up in the workplace and become a hazard or nuisance to workers. The converting facility took on the aroma of the fragrance that could potentially harm employees who may have been sensitive to the fragrance. Use of prior art fragranced liner materials was rarely adopted to fabricate closure seals due to the issues of controlling fragrance release. Further, closure seals once die-cut from the liner material stock continued to emanate absorbed or coated fragrance material causing similar exposure concerns at downstream converting and bottling facilities.

There remained a need in the prior art to supply liner materials suitable for fabrication into fragranced closure seals and other articles of manufacture and that avoided the disadvantage of uncontrolled fragrance release.

### SUMMARY OF THE INVENTION

In accordance with the principles of the present invention, a liner material is provided that contains an active material, such as a fragrance material, absorbed on a substrate layer, coated on the surfaces of the substrate layer, or both. In one embodiment, the fragrance material may be added to the substrate layer in an enclosure to control nuisance odors in the liner material manufacturing facility.

In one embodiment of the present invention, a water-soluble material that is impermeable to the active material is next applied to the top and bottom surfaces of the substrate layer to form overlying, impermeable protective layers that preclude emanation or volatilization of the active material from the substrate layer.

With the active material, for example a fragrance material, so enclosed, no fragrance material from the substrate layer enters the workplace at converting and bottling facilities. The fragrance material is of a type that does not permeate through nor dissolve the impermeable protective layers overlying the top and bottom surfaces of the absorbent substrate layer. The fragrance material does not volatilize and emanate from the substrate layer until the protective coating is dissolved and removed.

For use with liquid containing containers, the liner material is next converted into closure seals and placed into container closures. After the closures are connected to the container necks of liquid-containing containers, fragrance may be released into the headspace of the containers. Any water contained in the container liquid produces water vapor at saturation partial pressure in the headspace of the container. The water vapor acts to dissolves the impermeable, water-soluble protective layer overlying the absorbent substrate layer forming the closure seal. Alternatively, water-containing liquid may splash on the closure seal during container transit to likewise dissolve the impermeable water-soluble protective layer. In another embodiment, the container is intentionally inverted after closure placement to assure liquid contact with the soluble protective layer. The fragrance material absorbed on the substrate layer is thus released so that when a consumer opens the container a pleasant fragrance is noticed. Significant reductions in the required amount of fragrance material for the closure seals may be realized over prior art fragranced closure seals.

In another embodiment, the liner material need not be absorbent. In this embodiment, fragrance is coated as a fragrance layer on one or more non-absorbent substrate layer surfaces and then overlain with one or more respective impermeable water-soluble protective layers. Alternatively, the protective layers may be separately formed and next laminated to the fragrance layer on the surface of the substrate layer.

In yet another embodiment, the protective layer and the fragranced substrate layer may be co-extruded in a manner well known to those of ordinary skill in the art. Other means for fabricating encapsulated fragranced liner material in accordance with the principles of the present invention would be apparent to those skilled artisans.

Liner materials containing a water-soluble protective layer encapsulating active materials other than fragrance material are also possible. For example, water-soluble, impermeable protective layers may encapsulate a substrate layer having an antibacterial or disinfecting agent layer thereon. The disinfecting material is released upon contact of the impermeable, water-soluble protective layer with, for example, food juices or waste liquids. In one example, the liner material of the present invention is placed at the bottom of a cat litter pan to advantageously release odor maskants, fragrances or disinfectants as waste liquids contact the liner.

Further features and advantages of the present invention will become apparent to those of ordinary skill in the art in view of the detailed description of embodiments below.

### BRIEF DESCRIPTION OF THE DRAWINGS

Reference will now be made to the drawings wherein like numerals refer to like parts throughout. As used herein, positional terms, such as “bottom” and “top” and the like, and directional terms, such as “up” and “down” and the like, are employed for ease of description in conjunction with the drawings. These terms are not meant to indicate that the components of the present invention must have a specific orientation except when specifically set forth below.

FIG. 1 shows a side sectional view of a liner material in accordance with the principles of the present invention having an absorbent substrate layer and an active material absorbed within the substrate layer, a first protective layer on the top surface of the substrate layer, and a second protective layer on the bottom surface of the substrate layer;

FIG. 2 shows a side sectional view of a liner material in accordance with the principles of the present invention having substrate layer that is a partially absorbent; and

FIG. 3 shows a side sectional view of a liner material in accordance with the principles of the present invention having a non-absorbent substrate layer.

### DETAILED DESCRIPTION

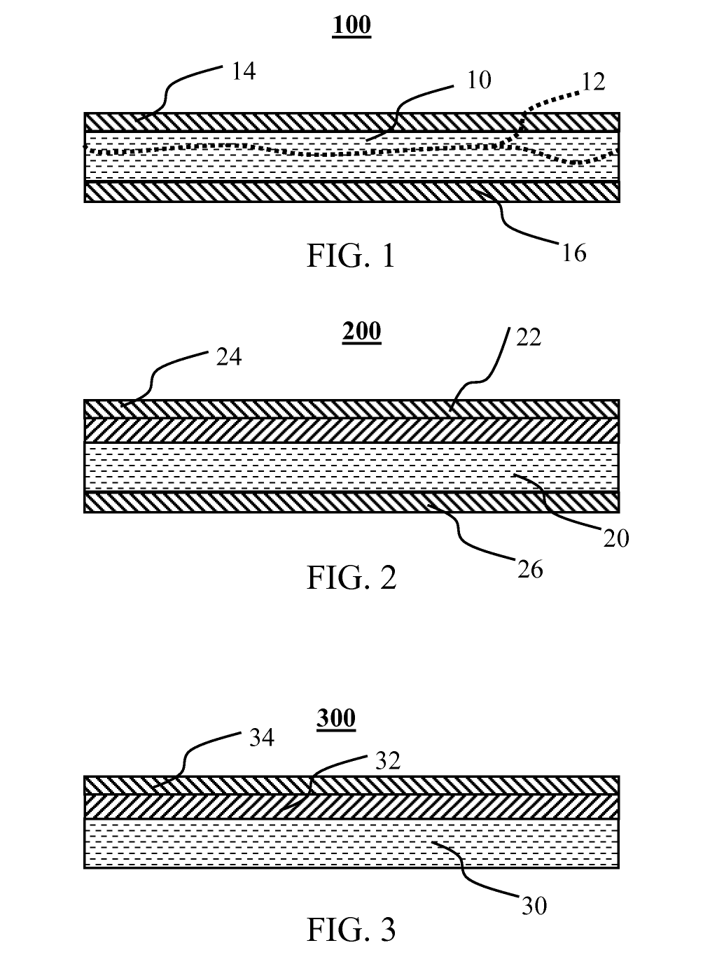

As shown in side cross-section in FIG. 1, in one embodiment, a liner material 100 includes a substrate layer 10 that is absorbent. Absorbed within substrate layer 10 is an active material 12 as indicated in dotted line within substrate layer 10. In the embodiment of FIG. 1, substrate layer 10 is sufficiently absorbent such that all of active material 12 absorbs into substrate layer 10. Overlying active material 12 at the top surface of substrate layer 10 is a first protective layer 14. Underlying substrate layer 10 at the bottom surface of substrate layer 10 is a second protective layer 16. First protective layer 14 and second protective layer 16 are impermeable to active material 12. Further, active material is in a state that it does not dissolve first protective layer 14 and second protective layer 16.

When it is said herein that a layer is impermeable to a material it is meant that the layer sufficiently precludes the transmission of the material across the layer so that any material that is transmitted is so small that operation of the present invention is not frustrated. In one example, protective layers 14 and 16 are impermeable to active material 12 if the amount of active material 12, such as a fragrance material, that transmits across protective layers 14 and 16 is such that the concentration of the active material 12 emanated from substrate layer 10 does not cause adverse health or safety effects in a converting facility. In one embodiment, first protective layer 14 and second protective layer 16 are water-soluble. In another embodiment, first protective layer 14 and second protective layer 16 are solvent-soluble such that protective layers 14 and 16 dissolve in a solvent liquid that contains no water.

When it is said herein that an active material is in a state that the active material does not dissolve a protective layer it is meant the active material is in a state such or has properties such that it does not dissolve the protective layer to the point where the protective layer is ineffective. For example, a fragrance material dissolved in water may be applied to a substrate layer and subsequently dried to the point the dried active material does not dissolve a water-soluble protective layer.

After liner material 100 is fabricated as described above, emanation of active material 12 from substrate layer 10 is precluded so long as protective layers 14 and 16 are intact and undissolved. Said another way, substrate layer 10 and, more particularly, active material 12 absorbed therein, is encapsulated by first protective layer 14 and second protective layer 16.

In another embodiment, FIG. 2 shows a side sectional view of a liner material 200 in accordance with the principles of the present invention having substrate layer 20 that is a partially absorbent. Overlying, substrate layer 20 at the top surface of the substrate layer 20 is an active material layer 22. An active material such as a fragrance or disinfectant is applied as a powder or as a liquid in a spray or wash that subsequently dries to form active material layer 22. Since substrate layer 20 is partially absorbent, only a portion of the active material applied to substrate layer 20 absorbs into substrate layer 20 while the remaining portion of the active material deposits on the top surface of substrate layer 20 as a distinct active material layer 22. Active material layer 22 may also be pre-formed as a separate layer by means well known in the art and subsequently coupled to the top surface of substrate layer 20. For example, coupling of active material layer 22 with substrate layer 20 may be accomplished by means of co-extrusion, adhesive bonding, thermal bonding, static bonding, or other means.

Similar to the embodiment described above with reference to FIG. 1, overlying active material layer 22 at the top surface of substrate layer 20 is a first protective layer 24. Optionally, a second protective layer 26 at the bottom surface of substrate layer 20 underlies substrate layer 20. In some embodiments, the amount of active material absorbed within substrate layer 20 and making up active material layer 22 that migrates to the bottom surface of substrate layer 30 is sufficiently small that no protective layer is required on the bottom surface of substrate layer 20.

First protective layer 24 and second protective layer 26 are impermeable to the active material making up active material layer 22. First protective layer 24 precludes emanation and desorption of the active material from substrate layer 20 and from active material layer 22 while first protective layer 24 is intact and undissolved. Second protective layer 26 precludes emanation of the portion of the active material that absorbed and diffused to the bottom surface of partially absorbent substrate layer 20 while second protective layer 26 is intact and undissolved.

Examples of prior art liner materials 100 suitable for converting into container closure seals include pulp/paper laminations, foamed polyolefin co-extrusions (i.e. foamed polyethylene, foamed polypropylene),solid polyolefins, pressure sensitive foamed olefins, foam backed induction heat seals, one piece induction heat seals, other foamed and solid plastic films, and other compressible sheet materials or laminates and co-extruded combinations of these materials. Polyvinyl alcohols, gelatins, and other materials and combinations of materials that are soluble in water.

are examples of materials suitable for use in forming water-soluble protective layers to overlie fragranced substrate layers of the liner materials of the present invention. Active materials suitable for use with the present invention include fragrance oils, antimicrobials, and disinfectants.

In yet another embodiment, FIG. 3 shows a side sectional view of a liner material 300 in accordance with the principles of the present invention having a non-absorbent substrate layer 30. Overlying, substrate layer 30 at the top surface of the substrate layer 30 is an active material layer 32. An active material such as a fragrance or disinfectant is applied as a powder or liquid in a spray or wash that subsequently dries to form active material layer 32. Since substrate layer 30 is non-absorbent all of the active material deposits on the top surface of substrate layer 20 as a distinct active material layer 32. As with the embodiment described above with reference to FIG. 2, active material layer 32 may also be pre-formed as a separate layer by means well known in the art and subsequently coupled to the top surface of substrate layer 30.

Overlying active material layer 32 at the top surface of substrate layer 30 is a protective layer 34. In this embodiment, no protective layer is needed at the bottom surface of substrate layer 30 since substrate layer 30 is nonabsorbent. Thus, none of the active material making up active material layer 32 migrates to the bottom surface of substrate layer 30. In one embodiment, protective layer 34 is impermeable to active material layer 32 and is water-soluble. Protective layer 34 precludes emanation of the active material from active material layer 32 while first protective layer 24 is intact and undissolved.

Liner material 300 is particularly adapted to applications where a hard surface substrate layer 30 is required, such as on cutting board liners use to protect, for example, pull-out wooden food cutting boards commonly found in kitchens. Substrate layer 30 may be made from a non-absorbent material such as polypropylene, high-density polyethylene, polystyrene, crystalline polyethylene terephthalate, amorphous polyethylene terephthalate, polyvinyl chloride, and polycarbonate. These types of material are not easily cut through and thus offer protection to a wooden cutting board. In one embodiment, active material layer 32 on the top surface of substrate layer 20 may include antimicrobial or disinfecting material to protect against contamination of food cut on the liner. Food juices dissolve protective layer 34 to release the antimicrobial active material when needed.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself. For example, the liner material of the present invention may be uses in diapers to release an active material when wetted. As such, these changes and modifications are properly, equitably, and intended to be, within the full range of equivalence of the following claims.

We claim:

1. A liner material comprising:
a substrate layer;
an active material absorbed within said substrate layer;
a first protective layer on the top surface of said substrate layer; and
optionally, a second protective layer on the bottom surface of said substrate layer.

2. The liner material of claim 1 wherein said substrate layer is partially absorptive.

3. The liner material of claim 1 wherein said substrate layer comprises a material selected from the group consisting of paper, foamed polyethylene, pulp/paper laminations, foamed polyolefin co-extrusions, foamed polyethylene, foamed polypropylene,solid polyolefins, pressure sensitive foamed olefins, foam backed induction heat seals, one piece induction heat seals, and laminates and co-extruded combinations thereof.

4. The liner material of claim 1 wherein said active material is selected form the group consisting of fragrance oils, disinfectants, and antimicrobials.

5. The liner material of claim 1 wherein said first protective layer and said second protective layer are impermeable to said active material.

6. The liner material of claim 1 wherein said first protective layer and said second protective layer are water-soluble.

7. The liner material of claim 1;
wherein said first protective layer comprises a material selected from the group consisting of polyvinyl alcohols, gelatins, and other materials and combinations of materials that are soluble to water.
wherein said second protective layer comprises a material selected from the group consisting of polyvinyl alcohols, gelatins, and other materials and combinations of materials that are soluble to water.

8. The liner material of claim 1 wherein said first protective layer and said second protective layer are solvent-soluble.

9. A liner material comprising:
a substrate layer;
an active material layer on the top surface of said substrate layer; and
a protective layer on the top surface of said active material layer.

10. The liner material of claim 9 wherein said substrate layer comprises a material selected from the group consisting of polypropylene, high density polyethylene, metal foils and solid polyolefins.

11. The liner material of claim 9 wherein said active material is selected form the group consisting of fragrance oils, disinfectants, and antimicrobials.

12. The liner material of claim 9 wherein said protective layer is impermeable.

13. The liner material of claim 9 wherein said protective layer is water-soluble.

14. The liner material of claim 9;
wherein said protective layer comprises a material selected from the group consisting of polyvinyl alcohols, gelatins, and other materials and combinations of materials that are soluble to water.

15. The liner material of claim 9 wherein said protective layer is solvent-soluble.

16. A fragranced closure seal comprising:
a liner material comprising:
a substrate layer;
a fragrance absorbed within said substrate layer;
a first protective layer on the top surface of said substrate layer; and
optionally, a second protective layer on the bottom surface of said substrate layer;
wherein said liner material is configured such that said liner material is adapted to cooperate with a container closure for a container to form a seal between said container closure and said container.

17. The closure seal of claim 16 wherein said closure seal is configured as a thin disk inserted into said container closure adjacent the inside surface of the top of said container closure before said container closure is secured on said container.

18. The closure seal of claim 16 wherein said container is inverted after said container is filled with a liquid and after said container closure is secured on said container.
